(19) United States
(12) Patent Application Publication
(10) Pub. No.: US 2026/0342811 A1
(43) Pub. Date: Oct. 29, 2026

(54) DISCOVERY OF A DATA ATTACK SURFACE WITHIN A NETWORK

(71) Applicant: Superna Inc., Ottawa (CA)

(72) Inventor: Andrew MacKay, Ottawa (CA)

(73) Assignee: Superna Inc., Ottawa, ON (CA)

(21) Appl. No.: 19/189,747

(22) Filed: Apr. 25, 2025

(51) Int. Cl. H04L 9/40

(52) U.S. Cl. CPC H04L 63/1416; H04L 63/1433

(57) ABSTRACT

In a computer implemented method of discovering a data attack surface of a network, audit data for a plurality of datastores of the network is received, the audit data including time series data of access events to the plurality of datastores of the network. An access event identifies a host device accessing a datastore, a user identifier of the host device accessing the datastore, a timestamp of the access event, and an operation performed by the host device during the access event. Host devices and user identifiers accessing a datastore are identified based on the audit data. The host devices and user identifiers accessing datastores are correlated, the correlating identifying an intersection of the host devices and the user identifiers interacting with the plurality of datastores. The data attack surface of the network is generated based on the correlating the host devices and user identifiers accessing the plurality of datastores.

### BACKGROUND

Conventional device discovery tools typically take a device-centric approach to device discovery by attempting to identify devices on a network. For instance, conventional device discovery may operate by pinging devices within an IP subnet range, blindly looking for devices on the network. Port scans may then be performed to identify device types, manufacturers, installed software, etc. However, these conventional solutions of device discovery are typically very time consuming, slowly pinging addresses within an IP subnet regardless of whether there is actually a device connected. Furthermore, as conventional device discovery takes a long time, especially for larger networks such as enterprises, these solutions are unable to remain up to date, as devices may connect or disconnect to the network at any time, reducing the accuracy of device discovery.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 is a block diagram illustrating an example network including a device discovery system, in accordance with various embodiments.

FIG. 2 is a block diagram illustrating an example device discovery system, in accordance with various embodiments.

FIG. 3 is a block diagram of an example computer system upon which embodiments of the present invention can be implemented.

FIG. 4 is a flow diagram for a process for discovering a data attack surface of a network, according to various embodiments.

FIG. 5 is a flow diagram of procedures of a process for generating a data attack surface, according to various embodiments.

### DESCRIPTION OF EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “receiving,” “identifying,” “correlating,” “evaluating,” “generating,” “inputting,” “predicting,” “training,” “performing,” “mapping,” “determining,” “integrating,” sampling,” “classifying,” or the like, refer to the actions and processes of an electronic computing device or system such as: a host device, a host processor, a processor, a memory, a cloud-computing environment, a network attached storage (NAS) device, a system manager, a virtualization management server or a virtual machine (VM), among others, of a virtualization infrastructure or a computer system of a distributed computing system, or the like, or a combination thereof. The electronic device manipulates and transforms data represented as physical (electronic and/or magnetic) quantities within the electronic device's registers and memories into other data similarly represented as physical quantities within the electronic device's memories or registers or other such information storage, transmission, processing, or display components.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may include random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Overview of Discussion

Example embodiments described herein improve the performance of computer network device discovery. In various embodiments, a computer-implemented method of data attack surface detection is provided. Audit data for a plurality of datastores of the network is received, where the audit data includes time series data of access events to the plurality of datastores of the network. An access event identifies a host device accessing a datastore of the plurality of datastores, a user identifier of the host device accessing the datastore, a timestamp of the access event, the referenceable data of the datastore accessed, and an operation performed by the host device during the access event of the datastore. User identifiers and host devices accessing at least at least one datastore of the plurality of datastores are identified based on the audit data. The host devices and user identifiers accessing the plurality of datastores are correlated to identify an intersection of the host devices and the user identifiers interacting with the plurality of datastores. The data attack surface of the network is generated based on the correlating the host devices and user identifiers accessing the plurality of datastores.

Conventional device discovery tools typically take a device-centric approach to device discovery by attempting to identify devices on a network. For instance, the conventional device discovery may operate by pinging devices within an IP subnet range, blindly looking for devices on the network that might be there. Port scans may then be performed to identify device types, manufacturers, installed software, etc. The conventional solutions are not able to discover data on a host device or detect remote storage mounts connected to a datastore, e.g., network attached storage (NAS), object storage, or databases (relational, NoSQL, columnar). In particular, the conventional device discovery tools are not able to discover data access or user accounts used to access datastores. Moreover, conventional device discovery operations are typically time consuming, depending on the complexity of the network, the number of devices connected, device status, etc. As such, with devices often connecting and/or disconnecting to a network in combination with the long discovery time, the device discovery list can quickly become stale and not representative of the network at any particular point in time.

The described embodiments provide device discovery that can be used to identify a data attack surface by identifying the user identifiers and host devices that actually access the datastores of a network. Today, data is rarely stored on host devices, but rather in centralized datastores, including both structured and unstructured data. The term “attack surface” is generally used to describe all devices of a network that can access underlying datastores, as it is understood that any device is capable of accessing the data of centralized datastores. As used herein, the term “data attack surface” is used to describe the user identifier and corresponding host devices that actually do interact with the underlying datastores. As such, the data attack surface is generally much smaller than the broadly defined attack surface, as most host devices of a network, such as an enterprise network, do not actually interact with the underlying data. Even fewer host devices generally interact with critical data stored therein. By accessing and analyzing audit data associated with the datastores, the described embodiments provide a list or mapping of user identifiers and host devices that actually interact with data of the network, generating a data attack surface of the network. This smaller data attack surface can then be used for enhanced vulnerability management, e.g., by using the data attack surface as input for vulnerability assessment tools.

Audit data is received for a plurality of datastores of a network. The plurality of datastores can include structured data (e.g., relational databases) and/or unstructured data (object storage), and can include on-premises storage (e.g., NAS devices) or remote storage devices (e.g., cloud-based storage). The audit data is a log of user activities pertaining to data accesses (e.g., access events) of the data of the datastores, and includes time series data of accesses to the plurality of storage devices, where an access identifies a host device accessing the storage device of the plurality of storage devices, a user identifier of the host device accessing the storage device, and an operation performed by the host device during the access of the storage device. The audit data provides a connection between user identifiers that have actually accessed to the stored data of the datastores using the associated host devices, allowing for the identification of the user identifiers and host devices that have accessed the stored data.

In some embodiments, the audit data can include additional data corresponding to a risk level for the host devices and/or user identifiers, such as data related to user permissions and user data access patterns that correspond to user identifiers. For instance, the audit data can be supplemented with metadata associated with a user identifier to include data permissions (e.g., to which data access has been granted). In some embodiments, the audit data can include a quantity of data a user identifier has permission to access. This quantity of data can be represented as a numeric value. In some embodiments, the audit data can include metadata (e.g., a data access score) corresponding to a user identifier's frequency of access to data. In some embodiments, the audit data includes metadata indicating a recency of data access, for example as a recency of data access score that identifies a relative freshness of data access corresponding to a user identifier.

It should be appreciated that this additional audit data may be included in the audit data or may supplement the audit data, either by accessing the data from the datastores or by processing the audit data to generate the additional audit data. For example, an audit data collection module may collect the additional audit data directly from the datastore, or utilize different application programming interfaces (APIs) to collect the additional data (e.g., data related to user access permissions). The additional audit data may also, or alternatively, be generated based on the audit data, for example by comparing audit data received over time to determine the described usage patterns. The additional audit data can be used to enhance vulnerability management, for example by being provided to a vulnerability management, performance management, or data usage reporting tools.

In some embodiments, the generation of the data attack surface is supplemented by the additional data corresponding to a risk level for the host devices and/or user identifiers. The additional data can be correlated to the host devices and user identifiers to provide additional risk information within the data attack surface, thereby enhancing the performance of vulnerability management.

In accordance with the described embodiments, the datastores are configured to provide access to the audit logs, e.g., by enabling audit data streams for access. For example, this can be referred to as protocol auditing for NAS and object storage platforms. In some embodiments, event listeners and audit logs are generated by a database or data analytics software to track user data modifications and login/logoff records in order to meet security requirements. The audit data format includes timestamps, user identification, source IP address of the user host, user action (read, write, delete, insert, modify, etc.), and the path or resource location and object, file name, table name, and affected rows.

The host source IP enables the collection of host data attack surface information, which completes the mapping of the hosts that access data by revealing how, when, and from which source host they access it. For instance, the host data attack surface might represent an attack path for an attacker. Vulnerability management tools use attack path mapping functions to identify risks, including how an exploit could be used in an attack. This attack path and exploitability are factored into host remediation and patching prioritization. The described embodiment provide host to storage data access patterns and relationships. This ensures that scanning and remediation efforts are focused on high-risk hosts and user identifiers that could lead to a cyber data breach.

The described embodiments enhance the current state of the art of device discovery by utilizing audit data inputs from datastores (e.g., storage devices, databases, and data analytics tools) to generate a list of host devices and user identifiers that could potentially result in a cyber data breach. This list can include metadata such as source IP address, target IP address, type of data storage, type of user activity, and a list of users who have accessed the target storage device. In some embodiments, a list of users identified in audit logs along with metadata indicating the types of storage devices they have accessed and the date and time of their last access is produced. The correlation between a user identifier, a host device, and a target datastore can be leveraged to construct a map of all data at risk of compromise from specific hosts and user identities that can be used, for instance, in calculating and mitigating risk. Furthermore, by using the timestamps associated with the access events, devices of the network can be identified for any time or time range, up to and including runtime of the described device discovery, as all access events are maintained as time series data.

For example, the data attack surface can be integrated into vulnerability and exposure management systems, enabling a data-centric approach to remediation prioritization. Furthermore, the data and metadata gleaned from described embodiments can be combined with host vulnerability and risk scores from external sources. This integration allows vulnerability or exposure management solutions to develop predictive analytics. These analytics can identify high-risk hosts, storage devices, and user identities, facilitating targeted patching or hardening actions to mitigate data attack surface risk.

Utilizing audit data of datastores to identify user identifiers and host devices that actually access underlying data of a network, in accordance with the described embodiments, improves the performance of device discovery. Furthermore, using the identified user identifiers and host devices enhances the performance of vulnerability assessment over conventional solutions by monitoring and analyzing host devices and user identifiers that actual access the underlying data. Hence, the embodiments of the present invention greatly extend beyond conventional methods of device discovery of devices on a network. Moreover, embodiments of the present invention amount to significantly more than merely using a computer to perform device discovery. Instead, embodiments of the present invention specifically recite a novel process, rooted in computer technology, utilizing audit data maintained for datastores of a network to identify user identifiers and host devices that demonstrate a risk of vulnerability to the stored data of the datastores that is current at runtime.

### Example System for Device Discovery on a Network

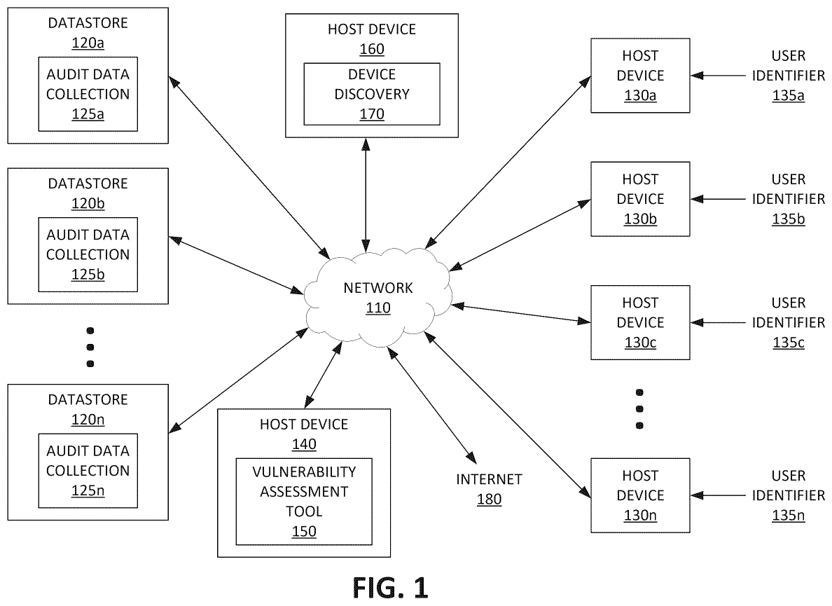

FIG. 1 is a block diagram illustrating an example network 110 including a device discovery system 170, in accordance with various embodiments. In accordance with the described embodiments, device discovery system 170 is configured to perform device discovery on network 110 for identifying host devices 130a-130n and user identifiers 135a-135n of network 110 that have access to at least one datastore 120a-120n. Network 110 includes datastores 120a-120n, host devices 130a-130n, host device 140, and host device 160. In some embodiments, network 110 is communicatively coupled to the Internet 180. It should be appreciated that network 110 can include any number of datastores 120a-120n, host devices 130a-130n, 140, and 160. Moreover, it should be appreciated that datastores 120a-120n, host devices 130a-130n, host device 140, and host device 160, can be standalone computing and/or storage devices (e.g., computer system 300) or can be distributed over multiple components (e.g., a virtualization infrastructure or a cloud-based infrastructure). In some embodiments, network 110 is comprised within or is an enterprise system.

Host devices 130a-130n (individually referred to herein as a host device 130) provide access to data stored within datastores 120a-120n (individually referred to herein as a datastore 120). Users associated with user identifiers 135a-130n (individually referred to herein as a user identifier 135) use host devices 130a-130n, respectively, to access the data stored within datastores 120a-120n. It should be appreciated that host devices 130a-130n and user identifiers 135a-130n might have different permissions and roles for accessing different data stored within datastores 120a-120n. For example, a user identifier 135 associated with a finance position within an enterprise might have access to different data of datastores 120a-120n than a user identifier 135 associated with a marketing position.

Datastores 120a-120n provides data storage for network 110. Datastores 120a-120n include audit data collection modules 125a-125n, respectively, that are configured to collect audit data according to data accesses of data stored at a respective datastore 120. It should be appreciated that datastores 120a-120n can include any type of structured or unstructured datastore. For example, datastores 120a-120n can include, without limitation, network attached storage (NAS), object storage, databases (e.g., relational, NoSQL, object-oriented, hierarchical, network, graph, columnar, and cloud), etc. It should also be appreciated that datastores 120a-120n can be on premises and/or remote (e.g., cloud storage).

The audit data includes time series data of accesses to the data stored at a corresponding datastore 120, where an access event identifies the data accessed at datastore 120, a timestamp of the time of the access event, a host device (e.g., host device 130) accessing datastore 120, a user identifier (e.g., user identifier 135) accessing datastore 120, and an operation (e.g., a data read or a data write) performed by the host device during the access event. The audit data for an access event can also include the data path and the referenceable data accessed (e.g., a resource location). Audit data collection modules 125a-125n collect and maintain audit data of access events, such that the audit data can be accessed by other services and applications, such as device discovery system 170 or vulnerability assessment tool 150. Datastores 120a-120n and/or audit data collection modules 125a-125n are configured to provide access to the audit logs, e.g., by enabling audit data streams for access, by device discovery system 170. It should be appreciated that the audit logs can be provided to device discovery system 170 using either a push mechanism or a pull mechanism.

In some embodiments, the audit data collected at audit data collection modules 125a-125n can include additional data corresponding to a risk level for the host devices and/or user identifiers, such as data related to user permissions and user data access patterns that correspond to user identifiers 135. For instance, the audit data can be supplemented with metadata associated with a user identifier 135 to include data permissions (e.g., to which data access has been granted). In some embodiments, the audit data can include a quantity of data a user identifier 135 has permission to access. This quantity of data can be represented as a numeric value. For example, the audit data can indicate a number of server message block (SMB) shares, NFS exports or S3 buckets of a datastore 120 to which a user identifier 135 has been granted access. The quantity of data shares that a user can access can also be provided as a percentage or quartile of data access. For example, a first user may have access to two shares having a corresponding 25% quartile score for data access, while a second user may have access to six shares having a corresponding 75% quartile score for data access.

In some embodiments, the audit data can include metadata (e.g., a data access score) corresponding to a user identifier's 135 frequency of access to data. For example, a first user that accesses more data than a second user may be assigned a higher data access score (e.g., 75^{th} percentile data access score versus a 25^{th} percentile data access score). In some embodiments, the audit data includes metadata indicating a recency of data access, for example as a recency of data access score that identifies a relative freshness of data access corresponding to a user identifier 135. For example, the recency of access data store can be provided on a scale of 1-100, where a low score (e.g., a recency of data access score of one) indicates recent access and a high score (e.g., a recency of data access score of seventy-five) indicates that data access to the datastore is not fresh.

It should be appreciated that this additional audit data may be included in the audit data or may supplement the audit data, either by accessing the data from datastore 120a-n at audit data collection modules 125a-n, respectively, or by processing the audit data to generate the additional audit data (e.g., at host device 160). For example, audit data collection module 125a may collect the additional audit data directly from datastore 120a, or utilize different application programming interfaces (APIs) to collect the additional data (e.g., data related to user access permissions) from datastore 120a. The additional audit data may also, or alternatively, be generated based on the audit data, for example by comparing audit data received over time to determine the described usage patterns, e.g., at host device 160. The additional audit data can be used to enhance vulnerability management, for example by being provided to various data or security management tools (e.g., vulnerability management tool 150).

As recited herein, a data attack surface includes user identifiers 135a-135n and host devices 130a-130n of network 110 that have access to datastores 120a-120n. The information regarding user identifiers 135a-135n and host devices 130a-130n of network 110 that have access to datastores 120a-120n is stored within audit logs of datastores 120a-120n (e.g., audit data collection modules 125a-125n). An example of the data (also referred to as metadata) collected and maintained with an audit log includes, without limitation (e.g., during user access events):
User identifier (e.g., usernames, accounts, roles, etc.): The user identifier tracks which user accesses specific data, identifying privileged users or potential insider threats.
Host devices (e.g., source device, destination devices, identified by IP address, etc.): Maps out the communication path between a host device and a datastore.
User operation (e.g., user-initiated actions such as read, write, delete, insert, modify, etc.): Tracks how the underlying data of a datastore is impacted by the user access.
Timestamp: Indicates the time of a user access event, providing time series data of user activity to analyze for determining normal user behavior or anomalous user behavior.
Referenceable data (e.g., a resource locator, a path/resource location, file name, table name, storage object, etc.): Identification of the files, database records, objects, etc., that were accessed and/or modified.

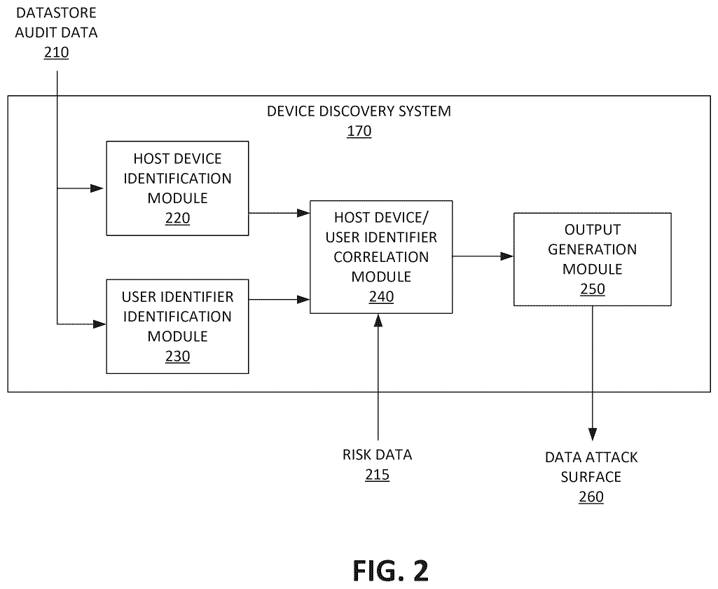

Device discovery system 170 is configured determine a data attack surface (e.g., data attack surface 260 of FIG. 2) by performing device discovery on network 110 for identifying host devices 130a-130n and user identifiers 135a-135n of network 110 that have access to at least one datastore 120a-120n. In some embodiments, device discovery system 170 is configured to supplement data attack surface 260 with the additional data corresponding to a risk level for the host devices 130a-130n and/or user identifiers 135a-135n. The additional data can be correlated to the host devices 130a-130n and user identifiers 135a-135n to provide additional risk information within the data attack surface, thereby enhancing the performance of vulnerability management.

In some embodiments, network 110 also includes at least one host device 140 including vulnerability assessment tool 150. Vulnerability assessment tool 150 is configured to receive collected data (also referred to herein as “vulnerability assessment data”) for determining host devices 130a-130n and user identifiers 135a-135n that demonstrate a risk of vulnerability to the data stored at datastores 120a-120n. In accordance with the described embodiments, vulnerability assessment tool 150 can receive the data attack surface from device discovery system 170. The use of the data attack surface generated at device discovery system 170 can improve the operation of vulnerability assessment tool 150 by providing list of the user identifiers and host devices that actual interact with datastores 120a-120n, which are the user identifiers and host devices that demonstrate a risk of vulnerability to the stored data of the datastores.

FIG. 2 is a block diagram illustrating a device discovery system 170, in accordance with various embodiments. Device discovery system 170 is configured to generate a data attack surface 260 based on an analysis of datastore audit data 210 (e.g., audit logs of datastores 120a-120n, audit data collection modules 125a-125n). Device discovery system 170 includes host device identification module 220, user identifier identification module 230, host device/user identifier correlation module 240, and output generation module 250. It should be appreciated that host device identification module 220, user identifier identification module 230, host device/user identifier correlation module 240, and output generation module 250, can be under the control of a single component of an enterprise computing environment (e.g., a distributed computer system, host device 160, or computer system 300) or can be distributed over multiple components (e.g., a virtualization infrastructure or a cloud-based infrastructure). Device discovery system 170 is configured to generate data attack surface 260, including host devices and user identifiers that access datastores 120a-120n.

Host device identification module 220 and user identifier identification module 230 receive datastore audit data 210, including audit data for datastores 120a-120n (e.g., audit data from audit data collection modules 125a-125n). Host device identification module 220 identifies the host devices of network 110 accessing at least one datastore 120 based on datastore audit data 210. User identifier identification module 230 identifies the user identifiers of network 110 accessing at least one datastore 120 based on datastore audit data 210.

Host device/user identifier correlation module 240 receives the host devices and user identifiers of network 110 accessing at least one datastore 120 from host device identification module 220 and user identifier identification module 230, respectively. Host device/user identifier correlation module 240 is configured to correlate the host devices and user identifiers accessing the plurality of datastores by identifying an intersection of the host devices and the user identifiers interacting with the plurality of datastores. Correlating the host devices (e.g., source IP addresses) with datastores accessed according to the audit logs allows for the generation of a data attack surface. The intersection of user identifiers and host devices interacting with the datastores allows for the mapping of data attack surface. For example, a vulnerability assessment tool 150 could detect anomalous user access behavior by comparing access patterns over time.

In some embodiments, device discovery system 170 is configured to supplement data attack surface 260 with risk data 215 comprising additional data corresponding to a risk level for the host devices 130a-130n and/or user identifiers 135a-135n. In some embodiments, host device/user identifier correlation module 240 also receives risk data 215 and is configured to correlate the host devices and user identifiers accessing the plurality of datastores with risk data 215. As presented above, risk data 215 can include, for example, data associated with data permissions user data access patterns, or other data related to a risk of breach associated with host devices 130a-130n and/or user identifiers 135a-135n. Risk data 215 can be correlated to the host devices 130a-130n and user identifiers 135a-135n to provide additional risk information within data attack surface 260, thereby enhancing the performance of vulnerability management utilizing data attack surface 260. It should be appreciated that risk data 215 may be comprised within datastore audit data 210, or may be a separate data stream to host device/user identifier correlation module 240.

It should be appreciated that device discovery system 170 is capable of generating data attack surface 260 for any point or range of time for network 110, as the audit data includes time series data of access events. In some embodiments, device discovery system 170 generates the data attack surface 260 at runtime. In other embodiments, device discovery system 170 generates the data attack surface 260 for a prior time range, allowing for historical analysis of data accesses to datastores 120a-120n for use in data breach investigations.

Output generation module 250 is configured to generate data attack surface 260, including an intersection of the host devices and the user identifiers interacting with the datastores. In some embodiments, data attack surface 260 includes a list of the host devices accessing at least at least one datastore of the datastores. In some embodiments, data attack surface 260 includes a list of the user identifiers accessing at least at least one datastore of the datastores. In some embodiments, data attack surface 260 includes a map of the data attack surface of the user identifiers and host devices accessing at least at least one datastore of the datastores, where the map traces routes from host devices and user identifiers to the data accessed.

In accordance with some embodiments, the determination of data attack surface 260 by device discovery system 170 allows for vulnerability management and assessment tools to focus on host device/datastore interactions that identify actual data access events. These host devices, and the associated user identifiers of the access events, identify the high risk host devices and user identifiers, and can be prioritized for vulnerability assessment, allowing for remediation prior to actual data breaches.

With reference to FIG. 1, vulnerability assessment tool 150 is configured to receive data attack surface 260 for performing vulnerability assessment. In some embodiments, a relative risk of host devices and/or user identifiers accessing datastores 120a-120n can be determined considering various factors. For example, and without limitation, vulnerability assessment tool 150 can consider the following factors in performing vulnerability assessment and the likelihood of exploitation of a host device:
Number of Unique Storage Systems Accessed: The greater the number of connections to the datastores, the larger the attack surface. This factor can be weighted by placing a higher risk on host devices accessing critical databases.
Number of High-Privilege Users on Host: This can indicate potential insider threats, and can be weighted more heavily on zero-trust security models.
User Permission Information: The quantity or relative amount of data to which a user has access can impact the potential impact of a data breach.
Frequency, Volume, and Recency of Data Access: Anomalous behavior in data access patterns can identify potential data exfiltration attempts, and can be compared to historical data access patterns for user (e.g., against normal user behavior baselines).
Known Vulnerabilities on Host: Host devices which access data should be monitored for known vulnerabilities and remediated. These vulnerabilities can be used by cross-checking a host device of the data attack surface against common vulnerabilities and exposure (CVE) databases.
Historical Security Incidents: Prior instances of host devices being involved in security events can be indicative of vulnerabilities. These host devices should be prioritized for remediation.

It should be appreciated that data attack surface 260 may be exported to and/or utilized by other vulnerability assessment or remediation tools (e.g., vulnerability assessment tool 150), supplementing the determination of vulnerable host devices for remediation.

### Example Computer System

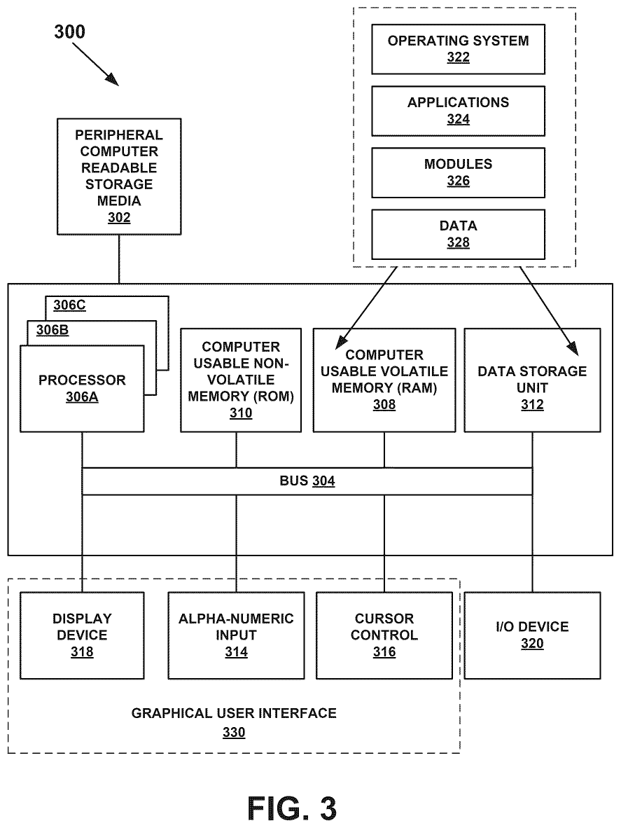

FIG. 3 is a block diagram of an example computer system 300 upon which embodiments of the present invention can be implemented. FIG. 3 illustrates one example of a type of computer system 300 (e.g., a computer system) that can be used in accordance with or to implement various embodiments which are discussed herein.

It is appreciated that computer system 300 of FIG. 3 is only an example and that embodiments as described herein can operate on or within a number of different computer systems including, but not limited to, general purpose networked computer systems, embedded computer systems, mobile electronic devices, smart phones, server devices, client devices, various intermediate devices/nodes, standalone computer systems, media centers, handheld computer systems, multi-media devices, and the like. In some embodiments, computer system 300 of FIG. 3 is well adapted to having peripheral tangible computer-readable storage media 302 such as, for example, an electronic flash memory data storage device, a floppy disc, a compact disc, digital versatile disc, other disc-based storage, universal serial bus “thumb” drive, removable memory card, and the like coupled thereto. The tangible computer-readable storage media is non-transitory in nature.

Computer system 300 of FIG. 3 includes an address/data bus 304 for communicating information, and a processor 306A coupled with bus 304 for processing information and instructions. As depicted in FIG. 3, computer system 300 is also well suited to a multi-processor environment in which a plurality of processors 306A, 306B, and 306C are present. Conversely, computer system 300 is also well suited to having a single processor such as, for example, processor 306A. Processors 306A, 306B, and 306C may be any of various types of microprocessors. Computer system 300 also includes data storage features such as a computer usable volatile memory 308, e.g., random access memory (RAM), coupled with bus 304 for storing information and instructions for processors 306A, 306B, and 306C. Computer system 300 also includes computer usable non-volatile memory 310, e.g., read only memory (ROM), coupled with bus 304 for storing static information and instructions for processors 306A, 306B, and 306C. Also present in computer system 300 is a data storage unit 312 (e.g., a magnetic or optical disc and disc drive) coupled with bus 304 for storing information and instructions. Computer system 300 also includes an alphanumeric input device 314 including alphanumeric and function keys coupled with bus 304 for communicating information and command selections to processor 306A or processors 306A, 306B, and 306C. Computer system 300 also includes a cursor control device 316 coupled with bus 304 for communicating user input information and command selections to processor 306A or processors 306A, 306B, and 306C. In one embodiment, computer system 300 also includes a display device 318 coupled with bus 304 for displaying information.

Referring still to FIG. 3, display device 318 of FIG. 3 may be a liquid crystal device (LCD), light emitting diode display (LED) device, cathode ray tube (CRT), plasma display device, a touch screen device, or other display device suitable for creating graphic images and alphanumeric characters recognizable to a user. Cursor control device 316 allows the computer user to dynamically signal the movement of a visible symbol (cursor) on a display screen of display device 318 and indicate user selections of selectable items displayed on display device 318. Many implementations of cursor control device 316 are known in the art including a trackball, mouse, touch pad, touch screen, joystick or special keys on alphanumeric input device 314 capable of signaling movement of a given direction or manner of displacement. Alternatively, it will be appreciated that a cursor can be directed and/or activated via input from alphanumeric input device 314 using special keys and key sequence commands. Computer system 300 is also well suited to having a cursor directed by other means such as, for example, voice commands. In various embodiments, alphanumeric input device 314, cursor control device 316, and display device 318, or any combination thereof (e.g., user interface selection devices), may collectively operate to provide a graphical user interface (GUI) 330 under the direction of a processor (e.g., processor 306A or processors 306A, 306B, and 306C). GUI 330 allows user to interact with computer system 300 through graphical representations presented on display device 318 by interacting with alphanumeric input device 314 and/or cursor control device 316.

Computer system 300 also includes an I/O device 320 for coupling computer system 300 with external entities. For example, in one embodiment, I/O device 320 is a modem for enabling wired or wireless communications between computer system 300 and an external network such as, but not limited to, the Internet. In one embodiment, I/O device 320 includes a transmitter. Computer system 300 may communicate with a network by transmitting data via I/O device 320.

Referring still to FIG. 3, various other components are depicted for computer system 300. Specifically, when present, an operating system 322, applications 324, modules 326, and data 328 are shown as typically residing in one or some combination of computer usable volatile memory 308 (e.g., RAM), computer usable non-volatile memory 310 (e.g., ROM), and data storage unit 312. In some embodiments, all or portions of various embodiments described herein are stored, for example, as an application 324 and/or module 326 in memory locations within RAM 308, computer-readable storage media within data storage unit 312, peripheral computer-readable storage media 302, and/or other tangible computer-readable storage media.

### Example Methods of Operation

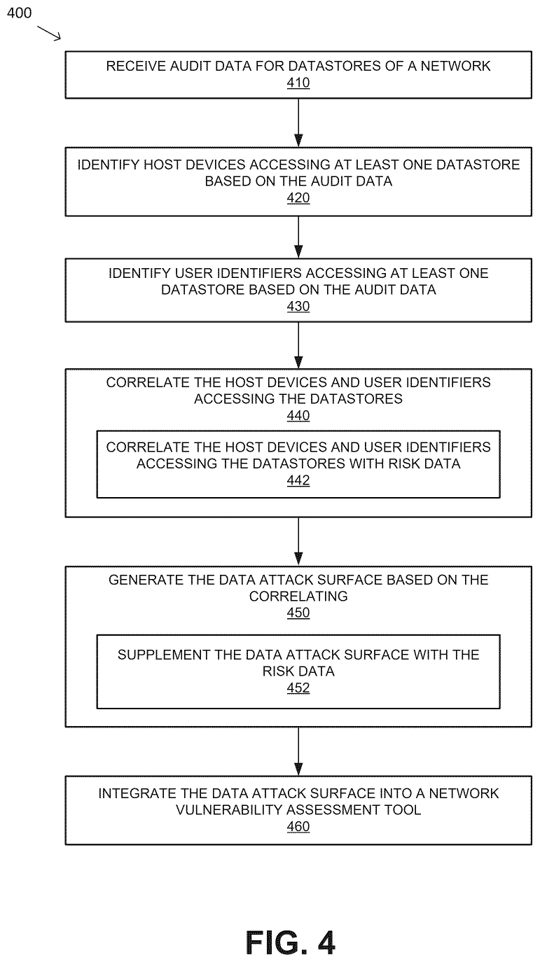

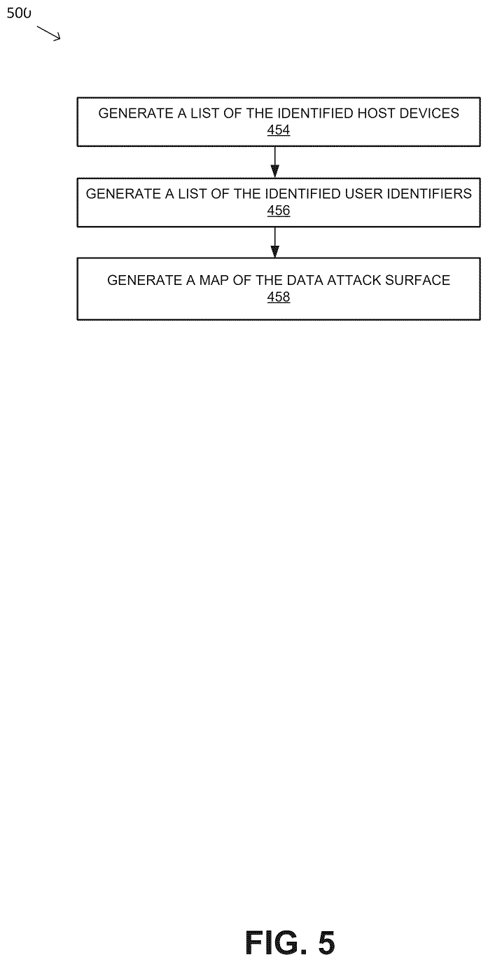

The following discussion sets forth in detail the operation of some example methods of operation of embodiments. With reference to FIGS. 4 and 5, flow diagrams 400 and 500 illustrate example procedures used by various embodiments. The flow diagrams 400 and 500 include some procedures that, in various embodiments, are carried out by a processor under the control of computer-readable and computer-executable instructions. In this fashion, procedures described herein and in conjunction with the flow diagrams are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments (e.g., computer system 300). The computer-readable and computer-executable instructions, which reside on tangible computer readable storage media, are used to control or operate in conjunction with, for example, one or some combination of processors of the computer environments and/or virtualized environment. It is appreciated that the processor(s) may be physical or virtual or some combination (it should also be appreciated that a virtual processor is implemented on physical hardware). Although specific procedures are disclosed in the flow diagram, such procedures are examples. That is, embodiments are well suited to performing various other procedures or variations of the procedures recited in the flow diagram. Likewise, in some embodiments, the procedures in flow diagram 400 may be performed in an order different than presented and/or not all of the procedures described in flow diagrams 400 and 500 may be performed. It is further appreciated that procedures described in flow diagrams 400 and 500 may be implemented in hardware, or a combination of hardware with firmware and/or software provided by computer system 300.

At procedure 410 of flow diagram 400, audit data is received for a plurality of datastores of a network. The audit data includes time series data of access events to the plurality of storage devices, an access event identifying a host device accessing the storage device of the plurality of storage devices, a user identifier of the host device accessing the storage device, a timestamp of the access event, and an operation performed by the host device during the access of the storage device. In some embodiments, the access event further identifies referenceable data of the datastore that is accessed. In some embodiments, the access event further identifies an action taken on the referenceable data. In some embodiments, the plurality of datastores comprises at least one structured datastore. In some embodiments, the plurality of datastores comprises at least one unstructured datastore. In some embodiments, the audit data comprises streaming data. In some embodiments, the audit data further includes additional data corresponding to a risk level for the host devices and user identifiers (e.g., user permissions for datastores or user data access patterns).

At procedure 420, host devices accessing at least at least one datastore of the plurality of datastores are identified based on the audit data. At procedure 430, user identifiers accessing at least at least one datastore of the plurality of datastores are identified based on the audit data. At procedure 440, the host devices and user identifiers accessing the plurality of datastores are correlated, the correlating identifying an intersection of the host devices and the user identifiers interacting with the plurality of datastores. In some embodiments, as shown at procedure 442, the host devices and user identifiers are correlated with the additional data corresponding to the risk level for the host devices and user identifiers.

At procedure 450, the data attack surface of the network is generated based on the correlating the host devices and user identifiers accessing the plurality of datastores. In some embodiments, the data attack surface identifies data of the plurality of datastores at risk of comprise by the host devices and user identifiers accessing the plurality of datastores. In some embodiments, the data attack surface of the network is supplemented with the additional data corresponding to the risk level for the host devices and user identifiers. In some embodiments, procedure 450 includes the procedures of flow diagram 500 of FIG. 5. FIG. 5 is a flow diagram of procedures of a process for generating a data attack surface, according to various embodiments. In some embodiments, as shown at procedure 452 of flow diagram 500, a list of the host devices accessing at least at least one datastore of the plurality of datastores is generated. In some embodiments, as shown at procedure 454, a list of the user identifiers accessing at least at least one datastore of the plurality of datastores is generated. In some embodiments, as shown at procedure 456, a map of the data attack surface of the network based on the correlating the host devices and user identifiers accessing the plurality of datastores is generated.

With reference to FIG. 4, in some embodiments, as shown at procedure 460, the data attack surface of the network is integrated into a network vulnerability assessment tool. In some embodiments, the identified host devices accessing at least at least one datastore of the plurality of datastores have associated metadata comprising an application programming interface (API) lookup into a vulnerability assessment tool to perform a vulnerability assessment on the identified host devices. In some embodiments, the identified host devices accessing at least at least one datastore of the plurality of datastores have associated metadata comprising an API lookup into an endpoint protection vendor software to perform an endpoint security assessment on the identified host devices.

In some embodiments, the identified user identifiers accessing at least at least one datastore of the plurality of datastores have associated metadata comprising access permissions of the identified user identifiers. In some embodiments, the access permissions and the intersection of the host devices and the user identifiers interacting with the plurality of datastores is used to predict a spread factor of malware across user identifiers through shared access permissions.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Many variations, modifications, additions, and improvements are possible, regardless the degree of virtualization. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims.

What is claimed is:

1. A computer-implemented method for discovering a data attack surface of a network, the method comprising:
receiving audit data for a plurality of datastores of the network, the audit data comprising time series data of access events to the plurality of datastores of the network, an access event identifying a host device accessing a datastore of the plurality of datastores, a user identifier of the host device accessing the datastore, a timestamp of the access event, and an operation performed by the host device during the access event of the datastore;
identifying host devices accessing at least at least one datastore of the plurality of datastores based on the audit data;
identifying user identifiers accessing at least at least one datastore of the plurality of datastores based on the audit data;
correlating the host devices and user identifiers accessing the plurality of datastores, the correlating identifying an intersection of the host devices and the user identifiers interacting with the plurality of datastores; and
generating the data attack surface of the network based on the correlating the host devices and user identifiers accessing the plurality of datastores.

2. The method of claim 1, wherein the access event further identifies referenceable data of the datastore that is accessed.

3. The method of claim 2, wherein the access event further identifies an action taken on the referenceable data.

4. The method of claim 1, wherein the generating the data attack surface of the network based on the correlating the host devices and user identifiers accessing the plurality of datastores comprises:
generating a list of the host devices accessing at least at least one datastore of the plurality of datastores.

5. The method of claim 1, wherein the generating the data attack surface of the network based on the correlating the host devices and user identifiers accessing the plurality of datastores comprises:
generating a list of the user identifiers accessing at least at least one datastore of the plurality of datastores.

6. The method of claim 1, wherein the plurality of datastores comprises at least one structured datastore.

7. The method of claim 1, wherein the plurality of datastores comprises at least one unstructured datastore.

8. The method of claim 1, further comprising:
integrating the data attack surface of the network into a network vulnerability assessment tool.

9. The method of claim 1, wherein the audit data comprises streaming data.

10. The method of claim 1, wherein the data attack surface identifies data of the plurality of datastores at risk of comprise by the host devices and user identifiers accessing the plurality of datastores.

11. The method of claim 1, wherein the generating the data attack surface of the network based on the correlating the host devices and user identifiers accessing the plurality of datastores comprises:
generating a map of the data attack surface of the network based on the correlating the host devices and user identifiers accessing the plurality of datastores.

12. The method of claim 1, wherein the identified host devices accessing at least at least one datastore of the plurality of datastores have associated metadata comprising an application programming interface (API) lookup into a vulnerability assessment tool to perform a vulnerability assessment on the identified host devices.

13. The method of claim 1, wherein the identified host devices accessing at least at least one datastore of the plurality of datastores have associated metadata comprising an API lookup into an endpoint protection vendor software to perform an endpoint security assessment on the identified host devices.

14. The method of claim 1, wherein the identified user identifiers accessing at least at least one datastore of the plurality of datastores have associated metadata comprising access permissions of the identified user identifiers.

15. The method of claim 14, wherein the access permissions and the intersection of the host devices and the user identifiers interacting with the plurality of datastores is used to predict a spread factor of malware across user identifiers through shared access permissions.

16. The method of claim 1, wherein the audit data further comprises additional data corresponding to a risk level for the host devices and user identifiers.

17. The method of claim 16, wherein the additional data corresponding to the risk level comprises user data access patterns for the user identifiers.

18. The method of claim 16, wherein the correlating the host devices and user identifiers accessing the plurality of datastores comprises:
correlating the host devices and user identifiers with the additional data corresponding to the risk level for the host devices and user identifiers.

19. The method of claim 18, wherein the generating the data attack surface of the network based on the correlating the host devices and user identifiers accessing the plurality of datastores comprises:
supplementing the data attack surface of the network according to the additional data corresponding to the risk level for the host devices and user identifiers.

20. A non-transitory computer readable storage medium having computer readable program code stored thereon for causing a computer system to perform a method for discovering a data attack surface of a network, the method comprising:
receiving audit data for a plurality of datastores of the network, the audit data comprising time series data of access events to the plurality of datastores of the network, an access event identifying a host device accessing a datastore of the plurality of datastores, a user identifier of the host device accessing the datastore, a timestamp of the access event, and an operation performed by the host device during the access event of the datastore;
identifying host devices accessing at least at least one datastore of the plurality of datastores based on the audit data;
identifying user identifiers accessing at least at least one datastore of the plurality of datastores based on the audit data;
correlating the host devices and user identifiers accessing the plurality of datastores, the correlating identifying an intersection of the host devices and the user identifiers interacting with the plurality of datastores; and
generating the data attack surface of the network based on the correlating the host devices and user identifiers accessing the plurality of datastores.
